(19) United States
(12) Patent Application Publication
(10) Pub. No.: US 2016/0211795 A1
(43) Pub. Date: Jul. 21, 2016

(54) Highly Integrated Foldable Array

(71) Applicant: Tao Sun, Suzhou (CN)

(72) Inventor: Tao Sun, Suzhou (CN)

(21) Appl. No.: 14/915,231

(22) PCT Filed: Aug. 11, 2014
(86) PCT No.: PCT/CN2014/084052

§ 371 Date: Feb. 27, 2016

(30) Foreign Application Priority Data
Aug. 28, 2013 (CN) 201310378344.1

(51) Int. Cl. H02S 30/20

(52) U.S. Cl. CPC H02S 30/20

(57) ABSTRACT

A highly integrated foldable photovoltaic array comprising at least two PV modules integrated boards and at least one intermediate support structure, at least two fixed hinges on the intermediate support structure; respectively by a hinge connection between the PV modules integrated with the intermediate support plate structure; at least two PV modules integrated plate in contact with the ground; the area of all PV modules on the photovoltaic array is greater than 18 square meters. The present invention may integrate foundations, brackets, cables, photovoltaic modules, inverters, combiner box, optimizer, PV module power detecting device, plug socket, etc. The highly integrated foldable photovoltaic array reduce intermediate process, thus greatly improve the speed of installation, expand its use, reduce installation costs. Its low profile greatly reduce the wind resistance.

### BACKGROUND OF THE INVENTION

1. Technical Field

The present invention relates to the field of solar photovoltaic technology, in particular to a highly integrated foldable photovoltaic array.

2. Description of Related Art

Solar are clean, inexhaustible. Most renewable energy such as wind, water potential, biomass is transformed from indirect solar. The fossil fuels such as coal, oil, natural gas also comes from ancient biomass. So, solar energy is the most important and most promising renewable energy.

However, the current market share of solar energy is less than 0.1 percent of the total electricity market. The main reason is the low efficiency of solar energy and the high costs. It's more expensive than fossil energy.

In the power generation costs, it should not only include the photovoltaic generator itself. It should also include management costs, space costs, capital costs, installation costs of construction, cleaning and maintenance costs, and so on. photovoltaic module conversion efficiency is only one aspect.

The vast majority of current photovoltaic industry have invested too much time and money to improve the cell efficiency itself, in a sense it is a mistake. Of course, the high labor costs in the region, the high conversion efficiency can reduce system installation costs. But many other methods can significantly reduce system installation costs. Therefore we have to consider what kind of integrated combination to achieve the lowest overall system cost.

The structure of most photovoltaic power ground plant with fixed angle has little change for decades.

The photovoltaic power plant is connected to the grid to transport electricity. The photovoltaic array is defined by a plurality of photovoltaic elements, the photovoltaic modules mechanically and electrically assembled together in a certain way and there is a fixed support structure constituted a power generation unit. Also called photovoltaic array photovoltaic arrays.

In general, the photovoltaic power plant may comprise a plurality of photovoltaic arrays.

The structure of the photovoltaic array can be divided into the following sections:

The bottom is the foundation, generally have the following: screw pile, strip concrete foundation blocks and concrete foundations.

In the above is mounting bracket, including columns, beams, purlins and so on. Usually with screws, they are simply supported structure.

Many photovoltaic modules are installed on the top. Then the PV modules are connect with cable, and coupled combiner boxes, distribution cabinets, inverters, transformers and other equipment, and finally connect on the power grid.

The photovoltaic systems are usually divided into several levels, the first level is the cell level, the smallest and indivisible. For crystalline silicon solar cells, which generally feature size (diameter or side length) of 125 mm, 156 mm, generally lower voltage and power. The second level is the module level, wherein the plurality of cells are connected in a single package. In crystalline silicon solar cell module, there are usually 60-72 cells encapsulated between glass and backsheet. The third level is the array level. In the tracking system, it is more obvious, the assembly of several photovoltaic modules on one axis is a photovoltaic array. The fourth level is the power plant level, the capacity is usually from a few hundred KW to several MW range. However, due to the lack of an intermediate level, you need install photovoltaic modules one by one, installation time is too long.

The cost of solar photovoltaic power plant typically includes the components cost, the cost of the bracket, foundation costs, labor costs, the cost of the inverter, and so on. Other cost without photovoltaic modules is also called BOS (balance of system) costs.

And now, the photovoltaic modules become much cheaper. Some module is lower to $0.7 per watt. Thus saving $0.01 is also difficult than before. The BOS costs in many cases is more than one US dollars, or even two-thirds of the total cost of power plant. Therefore BOS costs have become a major contradiction. The disadvantage of the prior art is a long time, high cost, the process is complicated.

From the natural law of the power industry development we know, the larger the scale, the cheaper the electricity. Wind power, thermal power, nuclear power, hydropower is the same. Thermal power from 200,000 kilowatts, 300,000 kilowatts has been developed to ultra-supercritical of 600,000 kilowatts; nuclear power is developed from 300,000, 600,000 to 1 million kilowatts. Therefore, the ideas is “bigger and stronger”. The average number of fixed costs can be reduced. The larger the capacity, the lower the cost.

The present size of the photovoltaic modules are slowly increased. It change from 60 cells to 72 cells before. However, it's difficult to improve further. A 72 cells photovoltaic module is 50 pounds, the size is 1.9 meters high and 1 meter wide. The photovoltaic module are made of glass and crystalline silicon cell, which is very thin, easy to crack. As the saying goes, “Wood show in the forest, the wind will destroy.” So if the existing structure does not change, the increase of the size may cause deformation. This will break the glass or silicon cells, resulting in unnecessary losses.

Today, many enterprises still spend a lot of resources to improve the efficiency, but did not realize that there is great potential to reduce labor costs with the quick installation techniques.

Therefore, how to reduce the installation time and installation costs of photovoltaic power plants has become a serious problem.

### SUMMARY OF THE INVENTION

For the prior art drawbacks, the present invention provides a highly integrated foldable photovoltaic array.

Highly integrated foldable photovoltaic array integrated many photovoltaic modules integrated boards, the intermediate support structure, and so on.

Photovoltaic modules integrated boards refers to a combination of several photovoltaic modules and the support structure which is easy to install and transport. It's large in order to have economies of scale. Therefore photovoltaic modules integrated board should contain multiple photovoltaic modules. In general, the total area of all photovoltaic modules on the integrated board should not be less than 5 square meters. Overall installation and transportation is to save labor, to avoid mounting and wiring respectively. It should be a elongated plate shape for transport in container. Obviously the photovoltaic modules should be located on the front to fully absorb sunlight. The support structure can be mounted on the back of the photovoltaic modules. The support structure can be a sandwichboard, pressed metal plate, frame and other forms. And photovoltaic modules integrated board contains multiple components, it is too heavy, usually difficult to lift by hand. It need the help of forklifts, cranes, loaders or the other tools.

Photovoltaic modules integrated boards can install multiple components, is a promising product. However, due to the conditions of carriage, as the size of the container, tunnel or railcar size it is very limited. The photovoltaic panels are integrated as a whole, and therefore its size is limited. For example, 20 feet ordinary container, the inner dimensions of 5.69 m×2.13×2.18 [symbol] m. And usually a 240 W photovoltaic module size is about 1.6 meters×1 meter photovoltaic module integrated board size is 5.6 m×2.1 m is within 20 feet of container a common photovoltaic panels installed vertically integrated photovoltaic modules can only be installed 5 240 W block components.

The present invention considers the above factors, technical solutions is: a highly integrated foldable photovoltaic array comprising at least two photovoltaic modules integrated boards and at least one intermediate support structure, characterized in that: at least two fixed hinges on the intermediate support structure; photovoltaic modules integrated boards and intermediate support structure are connected by hinge; at least two photovoltaic modules integrated boards in contact with the ground; the area of all photovoltaic modules on the photovoltaic array is greater than 18 square meters.

In order to transport more photovoltaic modules integrated boards, multiple integrated boards can be integrated with the hinge and connected with the intermediate support structure. It can be folded in a small size in the the container, expand to a large size when pull out the container. It greatly increased the number of photovoltaic modules in a single installation. The intermediate support structure may have a variety of different forms that include a plurality of connecting rods, the support plate, frame and so on. When should minimize the volume occupied after taking into account transportation folded thickness of the intermediate support structure should be as thin as some of the. A set in a part of an object to another object B, C, A moving object is limited C, but A can rotate in a plane around the C, A and B constitute the object of the hinge. Hinge connection is a specific form of rotating pairs.

Highly integrated foldable photovoltaic array comprising at least two photovoltaic modules integrated board, in order to get economies of scale. The installation of a highly integrated foldable photovoltaic array is equivalent to simultaneously install many photovoltaic modules integrated board. So the more photovoltaic modules integrated boards, the better. The total area of the photovoltaic array of photovoltaic modules is more than 18 square meters. The internal dimensions of ordinary 40-foot container is 11.8 m×2.13×2.18 [symbol] m. And usually a 240 W photovoltaic module size is about 1.6 m×1 m. photovoltaic modules is an integrated board area as a 11.8 m×2.1 m can only be installed vertically mounted 11 pcs 240 W photovoltaic modules. Within a 40-foot container common photovoltaic modules integrated board area is generally smaller than 18 square meters. The foldable photovoltaic array comprising at least two photovoltaic modules integrated boards. So the photovoltaic array should obviously be a little larger than a single photovoltaic modules integrated board. photovoltaic modules integrated board contact directly to the ground. It eliminate the need for ground installation, and reduce the corresponding costs. photovoltaic array itself has little weight, weight per square meter of the photovoltaic array is generally only a few kilograms per square meter and even very soft ground can carry several tons. So the photovoltaic array will not sink into the ground. For the photovoltaic array, the wind load is the main load. Yurts are very low wind resistance and very strong. It does not require a permanent foundation. A thick flat iron pad on the ground will not blow by the wind, so the low profile has good performance. But if the photovoltaic modules integrated board is too large, it is not easy to transport. Therefore, folding a large photovoltaic array is a better solution. When the photovoltaic array expanded on the ground, it will has a low profile. If we use the locking mechanism and connecting rods connect the adjacent photovoltaic array, it will has an even lower profile. In short this connection greatly reduce the wind resistance of the photovoltaic array, improve the speed of installation, greatly reducing the cost of photovoltaic power plants.

Preferably, the angle locking mechanism was mounted between the intermediate support structure and the photovoltaic modules integrated boards. After the angle locking mechanism lock the intermediate support structure and the photovoltaic modules integrated boards, the entire photovoltaic array is fixed. As we all know, the most stable structure is triangular structure. photovoltaic modules integrated board and the intermediate support structure constitutes the two sides of a triangular structure, and the locking lever is the third side. The angle locking mechanism use the locking lever, which can afford larger loads than other angle locking hinge. This is because the locking lever farther away from the hinge axis of rotation, can withstand greater torque. And specific locking mechanism include magnetic lock, thread lock, latch, and so on. With the angle locking mechanism, the entire photovoltaic array can be fixed without an extra screw. Door Stopper is a relatively common magnetically attached locking mechanism. photovoltaic modules can be designed to expand to a certain angle, then angle locking mechanism automatically lock, which is similar to the door and door stopper. The installation procedure is very complicated in the past, first install the foundation, and then install mounting bracket assembly, at last fix a lot of photovoltaic modules, tighten a lot of screws a lot, connect a lot of cables. The automatic angle locking mechanism make the complicated installation procedures to only one step. The installation steps is minimal.

Preferably, the support structure comprises at least two intermediate connecting rods. They are much stronger the a single connecting rod. If the wind load is too large, we can increase the number of the connecting rods.

Preferably, the photovoltaic array angle locking mechanism comprises at least one locking lever. As we all know, the most stable structure is the triangular structure. photovoltaic modules integrated board and the intermediate support structure constitutes two sides of a triangular structure, and the locking lever is the third side. If the locking lever is fixed, the angle between the photovoltaic modules and the intermediate support structure is fixed.

Preferably, the angle locking mechanism uses four hinge mechanism. The four hinge mechanism, when folded, is approximate a straight line, the transport volume is small; when fully expanded, is similar to a triangle. All components connect to the hinge. When expanded, it can bear the load immediately.

Preferably, the angle between the adjacent locking levers is less than 180 degrees, greater than 150 degrees. The angle between the adjacent locking levers is close to zero degree in folding position. That is less than 180 degrees is not fully extended, it is conducive to fold again.

Preferably, the photovoltaic array front row locking lever connected by a hinge. Such as front and rear locking lever is connected by a hinge, the front and rear rows of similarity, front and rear corners is the same. So if one locking lever is locked, the entire photovoltaic array is locked too. If every row has a separate locking mechanism, it's difficult to lock and unlock one by one, respectively. Front and rear intermediate support structure plate photovoltaic modules integrated with the locking lever is also formed a small triangle support structure. Thus the overall structure is more strong and robust.

Preferably, the angle locking mechanism is automatic. When the photovoltaic array expand to a certain angle, it is automatically locked.

Preferably, the locking lever connect the photovoltaic modules integrated boards and the intermediate support structure.

Preferably, the photovoltaic array was fixed to the back support structure. Back support structure can effectively support on the last row of photovoltaic modules integrated board. photovoltaic arrays without back support structure to rely on other additional structures such as walls, screw piles to support the last row of photovoltaic modules integrated board.

Preferably, the ratio of the the length of the photovoltaic array to the height of the photovoltaic array is greater than 2.

Preferably, the photovoltaic array connecting rods and locking lever are hollow thin-walled tube. Thin-walled hollow tube will save material costs.

Preferably, the fixture for interconnecting the adjacent array was mounted the photovoltaic array. Adjacent interconnected fixed photovoltaic arrays has much lower profile, which is more stable in the wind. It is possible to stand on the ground, even without using any foundation. That greatly simplifies the construction and reduces the cost.

Preferably, the photovoltaic array have an overhead layer under photovoltaic modules. In general, photovoltaic module should avoid direct contact with the ground, the component may have a corrosive effect. And the Uneven ground contact may cause solar cells cracked fault. The overhead layer makes photovoltaic modules a certain distance above the ground. This has many benefits. It makes forklift easy to lift the photovoltaic array. It can prevent moisture corrosion, and save material.

Preferably, the bottom plate is mounted under photovoltaic modules integrated pad. photovoltaic modules integrated boards should be in direct contact with the ground, which is the most reliable support. A thickened coating and paint can be used for moisture corrosion. But a bottom plate is more effective for prevent moisture corrosion. Meanwhile a special pad makes the rest of the photovoltaic modules integrated board structure greatly reduce the chance of contact with the ground, it does not require a strict anti-corrosion feature. This also reduces a lot of cost. The bottom plate also increases the ground contact area, reducing the pressure on the ground, easier to install on soft soil or desert.

Preferably, the photovoltaic array is pre-wired. It greatly reduce the time to connect cable manually. So that the plurality of cables in the photovoltaic array is connected to each other, without any extra cable and plug.

Preferably, the pre-wired cable are put into the connecting rods and levers.

Preferably, the photovoltaic modules integrated boards contain combiner box.

Preferably, the photovoltaic modules integrated boards contain inverter.

Preferably, the photovoltaic modules integrated boards contain optimizer, power detecting device.

Preferably, the sockets, switches are installed behind the photovoltaic modules integrated boards.

The integration of these components can reduce the connection between each other, and simplifies installation.

Such foldable photovoltaic array contain almost all of the relevant parts. So we can give customers a one-stop total solution, even can plug and play. Since the sun shine on the front surface, these components should be mounted on the back of the support structure.

The advantageous effects of the present invention are:

1, to enhance the speed of installation, simplifying the supply chain. Traditional photovoltaic power plant development process is very complicated. We need to find an EPC contractor (engineering, procurement and construction) building construction. And EPC will install the foundation, frame, modules, inverters, wire, etc. of various mechanical and electrical parts, respectively. The highly integrated foldable photovoltaic array includes a plurality of photovoltaic modules integrated board. This means that one can install multiple photovoltaic modules integrated board at the same time. The easiest installation requires only one step, the photovoltaic array can be expanded to the locked position, thereby saving time. Manufacturers shipped by container to the customer is already a finished product, rather than through intermediaries such as EPC, greatly simplifies the supply chain, increase the added value of products, has great economic value.

2, installation and removal time is shortened so that the new business model is possible. For example you can rent the photovoltaic array. And the photovoltaic array can be reused. In case of force majeure can not receive a reasonable tariff, the photovoltaic array can be removed as a whole, greatly reduces the risk of the investor. And the traditional photovoltaic array is difficult to move. The cost of removing and re-installing photovoltaic modules might even more expensive than photovoltaic modules itself. The second-hand photovoltaic arrays can also reduce the cost of solar energy, which greatly promoted the popularity of photovoltaic power generation.

3, highly integrated foldable photovoltaic array can be integrated almost all related components, including the foundation, frame, cable, photovoltaic modules, inverters, combiner box, optimizers, photovoltaic module power detecting devices, plugs and sockets, etc. You can even plug and play. Since photovoltaic modules integrated board itself straight contact with the ground, to reduce intermediate links, thus greatly improving the speed of installation, saving material costs. Low profile greatly reduces wind resistance. It is more difficult to do other techniques. Higher integration increases the speed of installation, which not only helps to reduce installation costs and also reduce the adverse impact on the geographical and climatic conditions of the construction, even in snow, soft soil or the tundra.

4, Installation and removal time is shortened greatly reducing labor costs. Removing shorten recovery time is also conducive to the component reuse.

5, Due to easy accessibility, it can be used for temporary space, little effect on the ground, and is reversible. After the demolition of the ground restitution. It can be used for other special venues such as fallow land. That greatly expanded its scope of application, and also greatly simplify the approval procedures.

6, Long life. Although disassembly are very quick, for emergency situations. But photovoltaic modules integrated board support structure integral, structural integrity, and the triangular structure by reasonable force. Able to withstand long-term wind and rain. Its warranty is up to ten years, more than any other fast installed photovoltaic systems. The same applies to photovoltaic power plants and other long-term applications.

In summary, high integration capability to quickly install and deploy collapsible photovoltaic array can not only reduce costs, but also greatly expanded its scope of application. Taking into account the large-scale solar industry's rapid development, its economic and social benefits are very high.

### BRIEF DESCRIPTION OF THE DRAWINGS

FIG. 1 is a perspective view of an embodiment of the invention after expansion.

FIG. 2 is a front view of an embodiment of the invention after expansion.

FIG. 3 is a plan view of an embodiment of the invention after expansion.

FIG. 4 is a partially enlarged plan view of an embodiment of the invention after expansion.

FIG. 5 is a side view of an embodiment of the invention after expansion.

FIG. 6 is a partially enlarged side view of an embodiment of the invention after expansion.

FIG. 7 is a perspective view of an embodiment of the invention before expansion. There is only one photovoltaic module in the drawing. Other photovoltaic modules are hidden to show the frame.

FIG. 8 is a rear view of an embodiment of the invention before expansion.

FIG. 9 is a plan view of an embodiment of the invention before expansion.

FIG. 10 is a side view of an embodiment of the invention before expansion.

FIG. 11 is a perspective view of an embodiment of the invention when semi-expanded.

FIG. 12 is a side view of the adjacent two interconnected photovoltaic arrays.

Parts Introduction: 1, photovoltaic modules integrated board; 10, photovoltaic module; 11, integrated board frame; 13, bottom plate; 14, gap; 16, locking hinge; 2, an intermediate support structure; 21, connecting rod; 22, an intermediate support structure hinge; 25, an intermediate support structure hinge; 26, locking hinge; 28, connecting rod; 3, angle locking mechanism; 31, locking lever; 32, locking hinge; 33, locking lever; 34, locking hinge; 35, locking lever; 36, locking hinge; 37, locking lever; 38, magnet support; 39, a magnet; 4, back support structure; 41, back support rod; 42, back support structure hinge; 43, bottom plate; 46, locking hinge; 5 photovoltaic modules integrated board; 50 photovoltaic module; 51, integrated board frame; 54, gap; 56, locking hinge; 8, accessory; 81, combiner box; 82, inverter; 83, plug; 84 cable; 86 optimizer; 9, interconnect fixture; 91, double hinge; 92, the fixing plate.

### EMBODIMENT OF THE INVENTION

Features and advantages of the invention was further described with reference to the drawings of the embodiments.

It should be understood that the specific embodiments described herein are only used to explain the present invention and are not intended to limit the present invention.

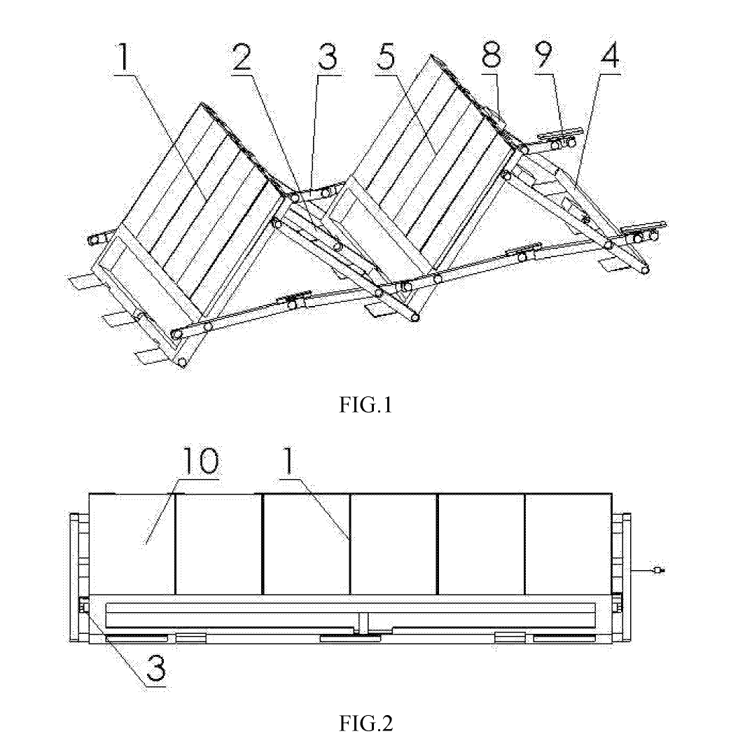

The particular embodiment is shown in FIG. 1 to FIG. 12. The present invention provides a highly integrated foldable photovoltaic array comprising at least two photovoltaic modules integrated board and at least one intermediate support structure; at least two fixed hinges on the intermediate support structure; photovoltaic modules integrated boards and intermediate support structure are connected by hinge; at least two photovoltaic modules integrated board in contact with the ground.

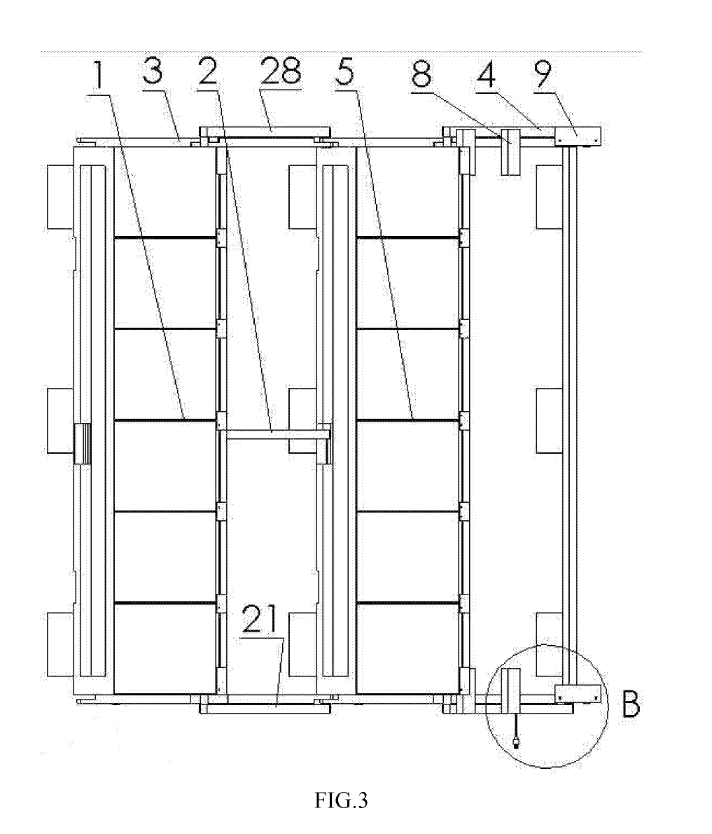

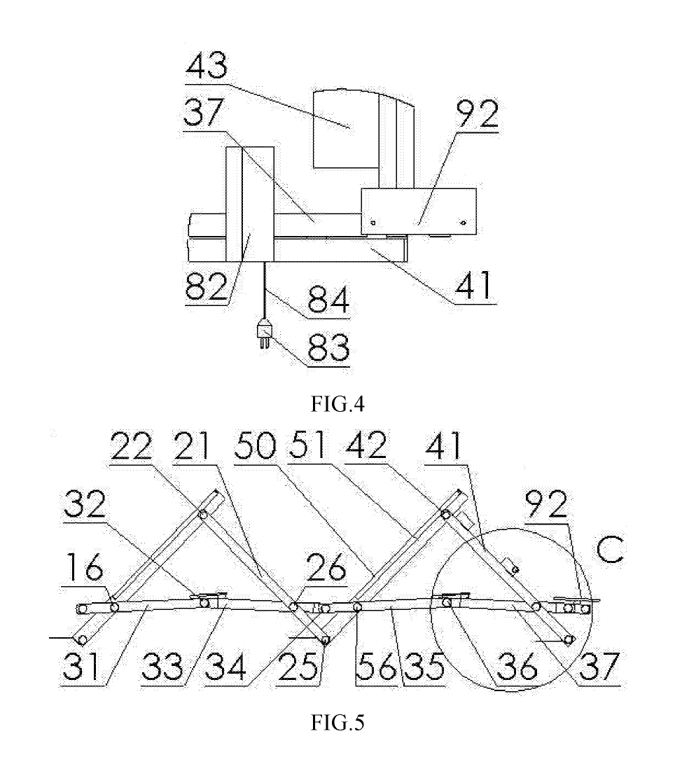

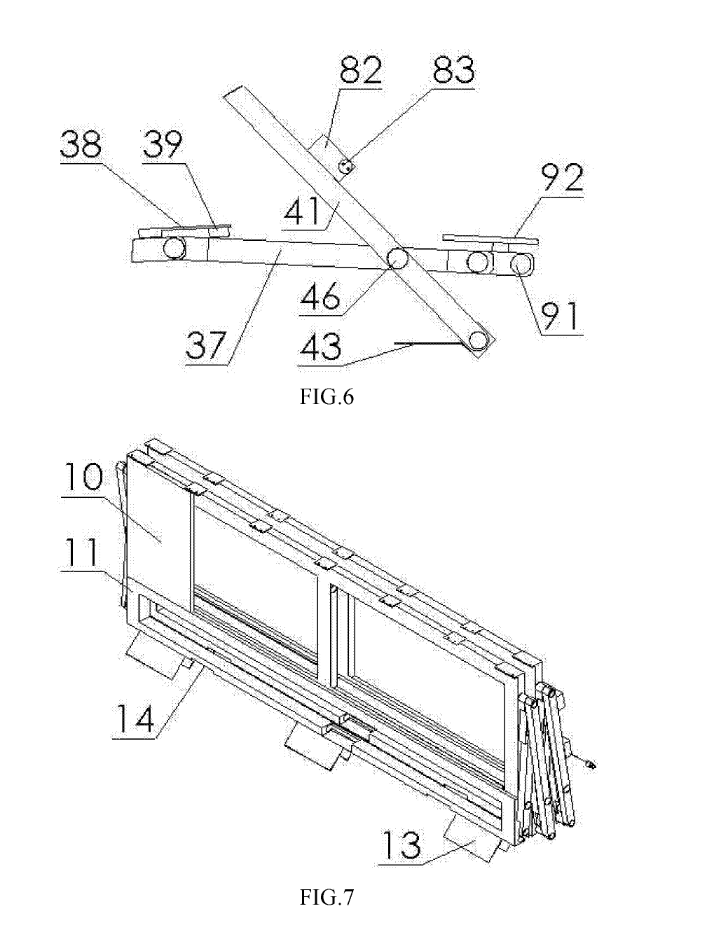

FIG. 1 is a perspective view of an embodiment of the invention after expansion. FIG. 2 is a front view of an embodiment of the invention after expansion. FIG. 3 is a plan view of an embodiment of the invention after expansion. FIG. 4 is a partially enlarged plan view of an embodiment of the invention after expansion. FIG. 5 is a side view of an embodiment of the invention after expansion. FIG. 6 is a partially enlarged side view of an embodiment of the invention after expansion.

Referring to FIG. 1,2,3,4,5,6, A photovoltaic array includes the front photovoltaic modules integrated board 1, the rear photovoltaic modules integrated board 5, the intermediate support structure 2 and the back support structure 4. The angle locking mechanism 3 is mounted between the photovoltaic modules integrated boards and support structures. the accessory 8 is fixed to on the back support structure 4. The adjacent photovoltaic arrays are connected to each other with the interconnect fixture 9.

The front photovoltaic modules integrated board 1 comprises photovoltaic module 10, integrated board frame 11, bottom plate 13, integrated board frame 16, etc. The locking hinge 11 is fixed on integrated board frame 16, the gap 14 is below integrated board frame 16. The rear photovoltaic modules integrated board 5 comprises photovoltaic module 50, integrated board frame 51, and so on. The locking hinge 11 is fixed on integrated board frame 56, integrated board frame is also fixed a locking hinge 56, the gap 54 is below integrated board frame 56. Gap is to facilitate the insertion of fork of forklift.

The bottom plate 13 is mounted under photovoltaic modules integrated pad. A bottom plate can help prevent moisture corrosion. The bottom plate also increases the ground contact area, reducing the pressure on the ground, easier to install on soft soil or desert.

As can be seen from FIG. 1, the photovoltaic array have an overhead layer under photovoltaic modules. In general, photovoltaic module should avoid direct contact with the ground, the solar panels may have a corrosive effect. And the Uneven ground contact may cause solar cells cracked fault. The overhead layer makes photovoltaic modules a certain distance above the ground. This has many benefits. It makes forklift easy to lift the photovoltaic array. It can prevent moisture corrosion, and save material.

Preferably, the support structure comprises at least two intermediate connecting rods. As can be seen from FIG. 3 connecting rod 21 and the connecting rod 28 was placed on two sides, can withstand more torque and save material. If the wind load is too large, we can increase the connecting rods in the middle. As it can be seen in FIG. 3, there is a connecting rod in the middle. The intermediate support structure 2 comprises a connecting rod and the hinge 22, the hinge 25. The front photovoltaic modules integrated board 1 is connected to the intermediate support structure 2 by a hinge 22, and the rear photovoltaic modules integrated board 5 is connected to the intermediate support structure 2 by a hinge 25. Foldable photovoltaic array using an intermediate support structure 2 connecting the front and rear rows of photovoltaic modules integrated board, significantly enhances the whole structure.

As can be seen from FIG. 5, the angle locking mechanism 3 comprises the locking lever 31, the lock lever 33, the lock lever 35, the lock lever 37 and so on. Preferably, the locking lever are located below the photovoltaic modules. So the photovoltaic modules will not stay in the shadow of the locking levers.

Four locking levers are connected by by the locking hinge hinge 32, the locking hinge 34, the locking hinge 36. Due to the similarity, the angle of rotation of front row and rear row is the same. So if one locking lever is locked, the whole structure is locked too. After expanded, intermediate support structure 2 and the rear photovoltaic modules integrated board 5 and the locking lever 33, the lock lever 35 is also formed a small triangle support structure. Thus the overall structure is more stable.

Four locking levers are connected to the photovoltaic modules integrated board 1, 5 and the intermediate support structure 2 and the back support structure 4 by the locking hinge 16, locking hinge 56, locking hinge 26, the hinge 46.

Preferably, the angle locking mechanism locks automatically. It rotate to a fixed angle to automatically lock. The present embodiment uses a magnetic mechanism. The locking mechanism comprises magnet support 38, magnet 39. As can be seen from FIG. 6, the magnet 39 will attract the lock lever 37 when expanded, and the lock lever 35 and the locking lever 37 will be fixed. Then the rear photovoltaic modules integrated board 5, the lock lever 35, the locking lever 37 and the back support structure 4 will constitutes an approximate triangle. So the entire photovoltaic array will be fixed.

Preferably, the photovoltaic array is fixed to the back support structure 4. Back support structure 4 can effectively support on the rear photovoltaic modules integrated board 5. photovoltaic arrays without back support structure to rely on other additional structures such as walls, screw piles supporting the last photovoltaic modules integrated board.

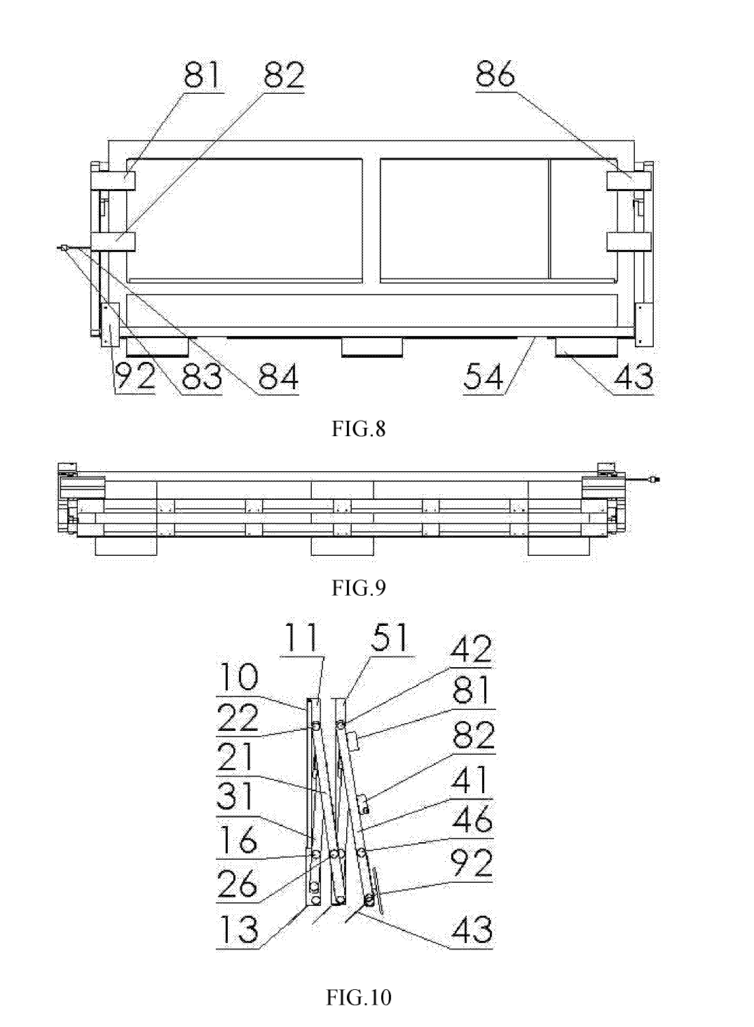

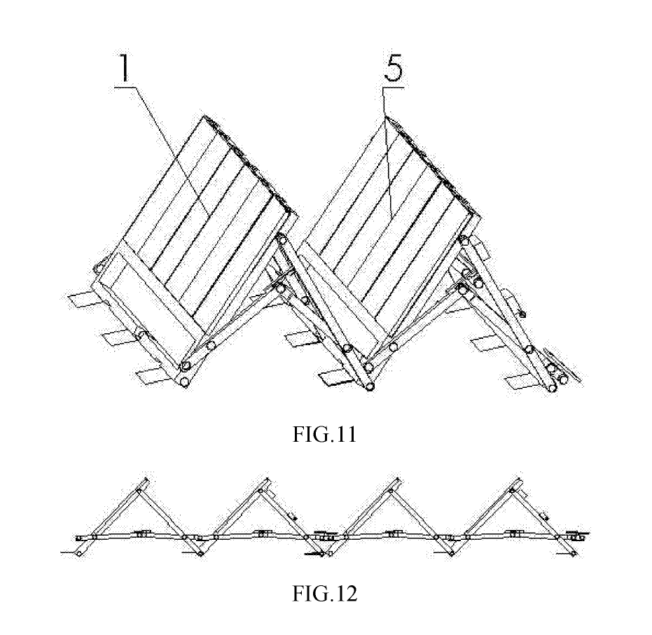

FIG. 7 is a perspective view of an embodiment of the invention before expansion. There is only one photovoltaic module. Other photovoltaic modules are hidden to show the frame. FIG. 8 is a rear view of an embodiment of the invention before expansion. FIG. 9 is a plan view of an embodiment of the invention before expansion. FIG. 10 is a side view of an embodiment of the invention before expansion. FIG. 11 is a perspective view of an embodiment of the invention when semi-expanded. FIG. 12 is a side view of the adjacent two interconnected photovoltaic arrays.

As it can be seen from the side view of FIG. 10, the photovoltaic array become very small when is folded, thus reducing transportation costs.

As can be seen from FIG. 1, 5, 7, 10, 11, the front photovoltaic modules integrated board 1 and the intermediate support structure is connected to the locking lever 32 and locking lever 34. This four constitute a four hinge mechanism. The four hinge mechanism, when folded, is approximate a straight line, transport volume is small; when expanded, it is similar to a triangle. As we all know, the most stable structure is triangular structure. When expand photovoltaic modules integrated board 1 and the intermediate support structure 2 are the two sides of a triangular structure. The locking lever 32 and the lock lever 34 is the third side. If the locking lever 32 and the lock lever 34 is locked, the entire photovoltaic array will be fixed.

Preferably, the interconnect fixture is mounted on the photovoltaic array. As can seen from FIG. 4, 6, 12, a double hinge 91 is fixed in the front photovoltaic array, the other hinge of the double hinge 91 can be connected to the rear photovoltaic array. The fixing plate 92 has screw holes, so double hinge 91 can fixed to the fixing plate 92 with screws. When the adjacent photovoltaic array connected, the profile of the whole structure become even lower relatively. The whole structure may not need any traditional foundation. It will greatly simplify the construction and reduce the cost.

As can be seen from the view of FIG. 8, the accessory 8 is fixed on the back of the support structure 4. Accessory 8 may include a variety of electrical components connected to the photovoltaic array.

Preferably, the combiner box 81 and the inverter 82 are fixed on the back of the support structure 4.

Preferably, the optimizer 86 is fixed on the back of the support structure 4.

Preferably, the plug 83 and the cable 84 are fixed on the back of the support structure 4.

The integration of these components can reduce the connection between each other, and simplify installation.

Preferably, the photovoltaic array is pre-wired. It greatly reduce the time to connect cable manually. So that the plurality of cables in the photovoltaic array is connected to each other, without any extra cable and plug.

In short, highly integrated foldable photovoltaic array can integrate almost all related components, including the foundation, frame, cable, photovoltaic modules, inverters, combiner box, optimizer, plugs and sockets and so on. The photovoltaic array can be plug and play. Higher levels of integration will help improve the speed of installation, reducing installation costs.

Furthermore, the foregoing descriptions of the embodiments of the present invention are provided for illustration only, and not for the purpose of limiting the invention as defined by the appended claims and their equivalents.

The invention claimed is:

1. A highly integrated foldable photovoltaic array, characterized in that it comprises at least two photovoltaic modules integrated boards and at least one intermediate support structure; it comprises at least two fixed hinges on the intermediate support structure; it comprises at least two photovoltaic modules integrated boards contact with the ground; the photovoltaic modules integrated boards are connected to intermediate support structure by hinge; the total area of all photovoltaic modules in the photovoltaic array is greater than 18 square meters.

2. The photovoltaic array according to claim 1, characterized in that the angle locking mechanism is mounted between the intermediate support structure and the photovoltaic modules integrated board.

3. The photovoltaic array according to claim 1, characterized in that the intermediate support structure includes at least two connecting rods.

4. The photovoltaic array according to claim 1, characterized in that said the back support structure is mounted in the photovoltaic array.

5. The photovoltaic array according to claim 1, characterized in that the bottom plate is mounted under the photovoltaic modules integrated boards.

6. The photovoltaic array according to claim 1, characterized in that the locking mechanism is mounted in the photovoltaic array for interconnecting adjacent photovoltaic arrays.

7. The photovoltaic array according to claim 1, characterized in that the photovoltaic modules on the photovoltaic array are pre-wired.

8. The photovoltaic array according to claim 1, characterized in that the combiner box is installed behind the photovoltaic modules integrated board.

9. The photovoltaic array according to claim 1, characterized in that there is a certain distance between the photovoltaic modules of the photovoltaic array and the ground.

10. The angle locking mechanism according to claim 2, characterized in that it comprises at least one locking lever.
